(19) United States
(12) Patent Application Publication
(10) Pub. No.: US 2010/0006791 A1
(43) Pub. Date: Jan. 14, 2010

(54) VALVE EXTENSION HANDLE AND METHOD OF USING THE SAME

(76) Inventors: Christopher Reckker, O'Fallon, MO (US); Gerald W. Ohmes, Wentzville, MO (US)

Correspondence Address: Patent Docket Department;Armstrong Teasdale LLP, One Metropolitan Square, Suite 2600, St. Louis, MO, 63102-2740, US

(21) Appl. No.: 12/170,052

(22) Filed: Jul. 9, 2008

(51) Int. Cl. F16K 31/00; B25G 1/10; B21D 51/16

(52) U.S. Cl. 251/293; 16/436; 29/890.12

(57) ABSTRACT

An extension handle is coupled to a flow control device of a railcar. The extension handle includes a first rod having a first end operatively coupled to the flow control device, an opposing second end forming a handle, and a midsection slidably coupled to a support member coupled to the railcar.

### BACKGROUND OF THE INVENTION

The field of the disclosure relates generally to flow control valves and, more particularly, to an extension handle for operating a flow control valve positioned on an underside of a railcar and a method for coupling the extension handle to the railcar.

Railcars have long been used to store and transport liquid, powdered and granular materials. These railcars may be cylindrical or rectangular in shape and include one or more enclosed hoppers that facilitate securely and efficiently transporting the materials to a destination while minimizing material loss during transport.

In at least some known railcars, the materials contained within the railcars are discharged from the railcar using a pneumatic discharge system. The materials may be discharged into a storage unit or into another transport vessel. In order to discharge the materials from the railcar, air is fed into the railcar hopper from an external source to pressurize an internal volume of the hopper. With the internal volume of the hopper pressurized, the pneumatic discharge system is utilized to unload the material from within the hopper. The pneumatic discharge system includes a network of material transfer lines or pipes and operatively coupled flow control valves for releasing a pressurized stream of material from within the hopper to discharge the material from within the hopper. Generally, the network of transfer lines or pipes and flow control valves runs beneath the railcar and is coupled to the underside of the railcar such that an operator of the railcar must maneuver beneath the railcar to manually open one or more of the flow control valves to release the material from within the hopper.

### BRIEF DESCRIPTION OF THE INVENTION

In one aspect, an extension handle is provided. The extension handle is coupled to a flow control device of a railcar, and includes a first rod having a first end operatively coupled to the flow control device, an opposing second end forming a handle, and a midsection slidably coupled to a support member coupled to the railcar.

In another aspect, a valve system is provided for a railcar including at least one hopper that defines a volume for containing a material and a material discharge system including a pipe that defines a first passage in material flow communication with the volume. The valve system includes a flow control device operatively coupled to the pipe. The flow control device includes a body defining a second passage. The first passage and the second passage are in flow communication. A valve is movably positioned within the second passage, and is movable between an open position allowing material flow through the second passage and a closed position limiting material flow through the second passage. An actuator is operatively coupled to the valve. The actuator is pivotally movably with respect to the body to move the valve between the open position and the closed position. An extension handle is coupled to the actuator to pivotally move the actuator with respect to the body.

In another aspect, a method for coupling an extension handle to a valve system of a railcar is provided. The railcar includes at least one hopper that defines a volume for containing a material and a material discharge system including a pipe that defines a first passage in material flow communication with the volume. The flow control device is operatively coupled to the pipe. The flow control device includes a body that defines a second passage and a valve movably positioned within the second passage. The first passage and the second passage are in flow communication. The valve is movable between an open position allowing material flow through the second passage and a closed position limiting material flow through the second passage. An actuator is operatively coupled to the valve and is pivotally movable with respect to the body to move the valve between the open position and the closed position. The method includes coupling an extension handle to the actuator to pivotally move the actuator with respect to the body.

In yet another aspect, a method for coupling a valve system to a railcar is provided. The railcar includes at least one hopper that defines a volume for containing a material and a material discharge system including a pipe that defines a first passage in material flow communication with the volume. The method includes operatively coupling a flow control device to the pipe. The flow control device includes a body that defines a second passage and a valve movably positioned within the second passage. The first passage and the second passage are in flow communication. The valve is movable between an open position allowing material flow through the second passage and a closed position limiting material flow through the second passage. An actuator is operatively coupled to the valve and pivotally movable with respect to the body to move the valve between the open position and the closed position. An extension handle is coupled to the actuator to pivotally move the actuator with respect to the body.

### BRIEF DESCRIPTION OF THE DRAWINGS

FIG. 1 is a top view of a valve system;

FIG. 2 is a front view of the valve system shown in FIG. 1;

FIG. 3 is a side view of the valve system shown in FIG. 1;

FIG. 4 is a front perspective view of a butterfly valve;

FIG. 5 is a top view of an extension handle of the valve system shown in FIG. 1;

FIG. 6 is a side view of the extension handle shown in FIG. 5; and

FIG. 7 is a side view of a railcar with a material discharge system including a valve system.

### DETAILED DESCRIPTION OF THE INVENTION

The present disclosure describes a valve system including a flow control device operatively coupled to a pipe in material flow communication with a hopper of a railcar. More specifically, the pipe defines a passage in material flow communication with a volume defined within the railcar hopper. The material is moved through the pipe passage to transfer the material from within the hopper into a suitable container for further transport and/or storage. The material transported within the railcar hopper includes powdered, granular or liquid material. An extension handle is operatively coupled to the flow control device to operate or control the flow control device. The extension handle extends laterally outward from the underside of the railcar and through a support member coupled to a side sill of the railcar to allow an operator to open and close a valve of the flow control device while standing next to the railcar and without having to crawl and/or reach under the railcar. Further, existing valve systems can be retrofitted to include the extension handle and the support member. During the retrofitting process, a conventional actuator, such as a squeeze trigger actuator, is replaced with an actuator as described herein. The support member is coupled to the railcar side sill using a suitable process, such as welding, and the extension handle is slidably positioned within an opening defined in the support member and coupled to the actuator. In one embodiment, the extension handle is removably coupled to the actuator.

The valve system and the extension handle are described below in reference to an application in connection with and operation of a pneumatic discharge system utilized to unload product or material from within a hopper of a railcar. However, it will be apparent to those skilled in the art and guided by the teachings herein provided that the disclosure is likewise applicable to any suitable system including one or more flow control valves utilized to control movement of a product or material through a pipe or piping system.

As used herein, references to “material flow” are to be understood to refer to a movement of material, such as a liquid, a gas, or a solid material or product, for example from within a container configured to contain the material and into and through a pipe or piping system configured to facilitate removing the material from within the container.

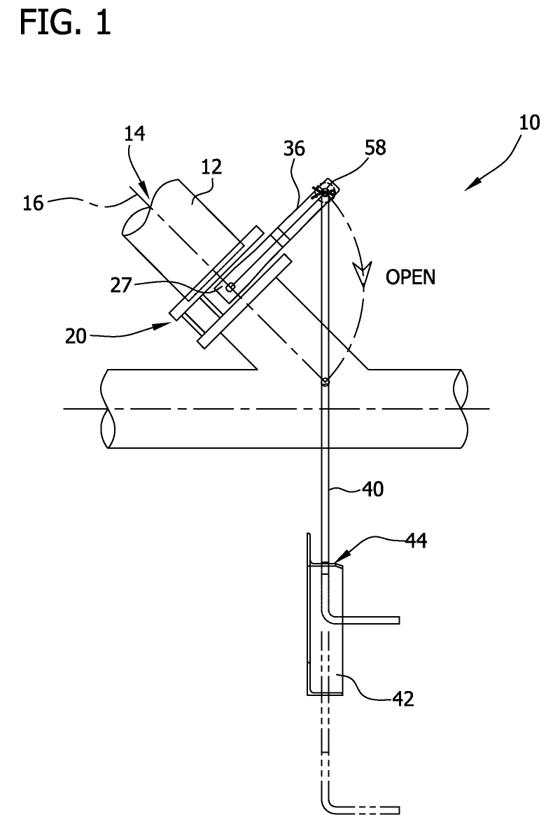

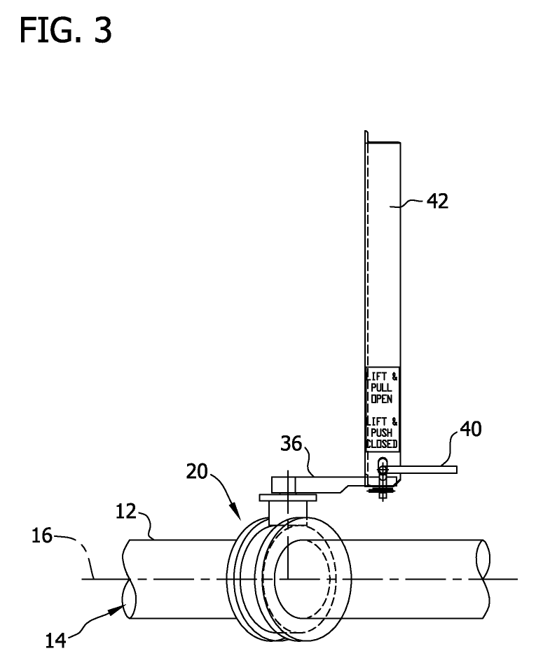

Referring to FIGS. 1-6, in one embodiment, a valve system 10 is operatively coupled to a material discharge system of a railcar configured to move material from within one or more hoppers of the railcar into a suitable container. The hopper defines a volume suitable for containing a material during transport. The discharge system includes one or more pipes 12 coupled to an underside of the railcar to facilitate transferring the material. Pipe 12 defines a passage 14 having a central axis 16. Passage 14, also referred to as a first passage or a pipe passage, is in material flow communication with the volume of the hopper to allow movement or flow of the material through pipe 12. Valve system 10 includes a flow control device 20 operatively coupled to pipe 12.

In one embodiment, flow control device 20 includes a body that defines a passage and a valve that is movably positioned within the body passage. This passage through the body of device 20 is sometimes referred to as the body passage or the second passage. The valve is movable between an open position allowing material flow through the body passage and a closed position limiting material flow through the body passage. An actuator is operatively coupled to the valve, and pivotally movably with respect to the body to move the valve between the open position and the closed position.

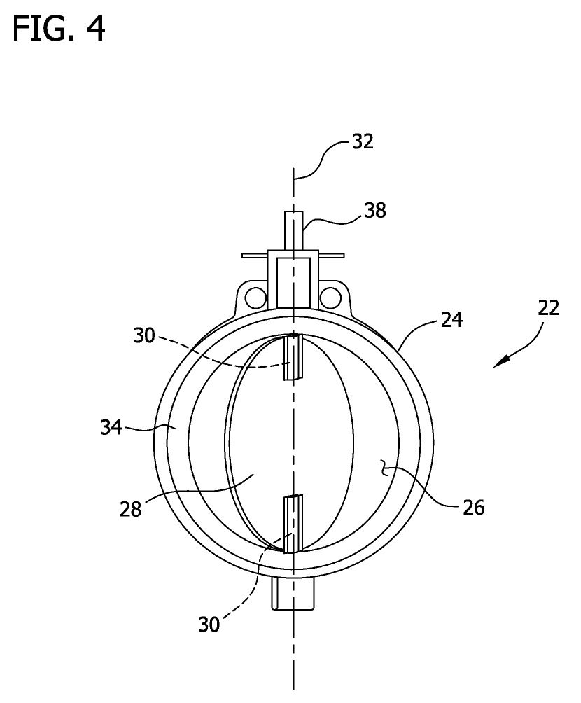

Referring further to FIG. 4, in one embodiment, flow control device 20 includes a butterfly valve 22. Butterfly valve 22 includes a body 24 that defines a passage 26 in material flow communication with passage 14 defined through pipe 12 and having a central longitudinal axis 27 aligned with central axis 16 of passage 14. A disk 28 is movably positioned within passage 26. In this embodiment, disk 28 has an elliptical surface area, such as a circular surface area, and is positioned within passage 26 to regulate a fluid flow, such as a flow of material, through a section of pipe 12. Disk 28 is rotatably coupled within passage 26 to body 24. In a particular embodiment, disk 28 is mounted on one or more pins 30 that extend along at least a portion of an axis 32 of disk 28 defining a diameter of disk 28. Pins 30 extend outwardly from disk 28 to rotatably couple disk 28 to body 24. With pins 30 rotatably positioned within a corresponding void in body 24, disk 28 is movable within passage 26 between a first or closed position limiting material flow through passage 26 and a second or open position allowing material flow through passage 26. In the closed position, disk 28 is oriented substantially perpendicular to central axis 27 to prevent or limit material flow through passage 26. In a particular embodiment, butterfly valve 22 includes a resilient seat 34 that compresses with disk 28 in the closed position to provide a seal about a periphery of disk 28. In the open position, disk 28 is oriented substantially parallel to central axis 27 to allow material flow through passage 26. In an alternative embodiment, a rod or another suitable coupler (not shown), in lieu of pins 30, rotatably couple disk 28 to body 24.

An actuator 36 (shown in FIGS. 1-3) is coupled externally to body 24. Actuator 36 is operatively coupled to disk 28 and is pivotally movable with respect to body 24 to move disk 28 between the open position and the closed position. In one embodiment, actuator 36 is coupled to a stem 38 that is operatively coupled to disk 28, as shown in FIG. 4. Actuator 36 is pivotally movable between a first position corresponding to the closed position of disk 28 and a second position corresponding to the open position of disk 28. In the first position, actuator 36 is oriented substantially perpendicular to central axis 27 and, in the open position, actuator 36 is oriented substantially parallel to central axis 27. In this embodiment, actuator 36 is turned one quarter turn to rotate disk 28 90° between the open position and the closed position.

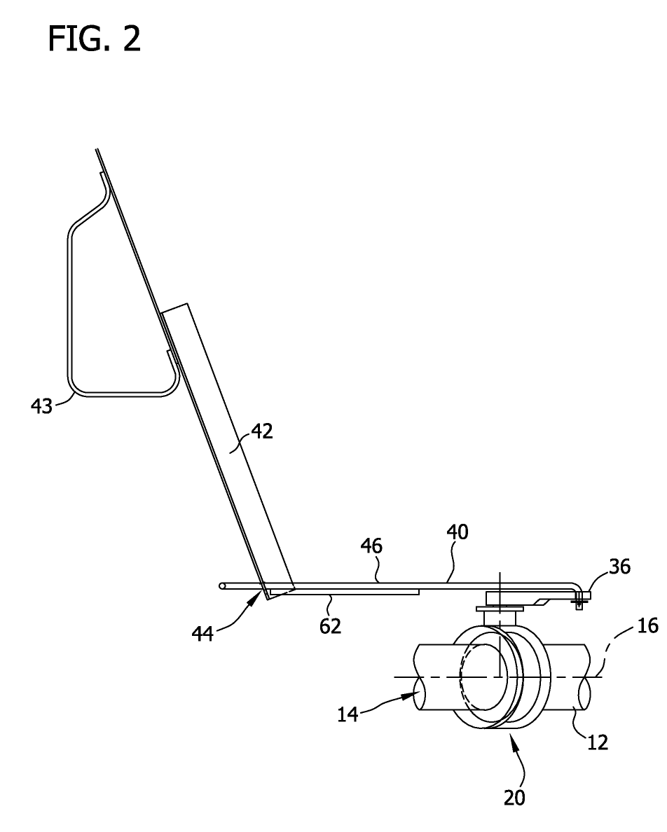

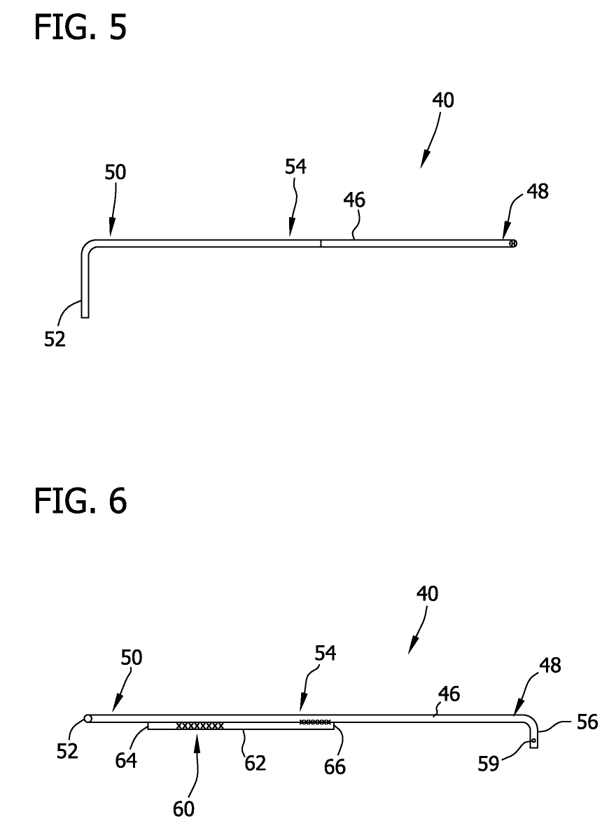

Valve system 10 includes an extension handle 40 coupled to flow control device 20. A support member 42 is coupled to the railcar, such as to a side sill 43 of the railcar shown in phantom lines in FIG. 2, to support extension handle 40. In one embodiment, support member 42 defines an opening 44 through which extension handle 40 is slidably positioned. Opening 44 has suitable dimensions for receiving extension handle 40. Referring further to FIGS. 5 and 6, extension handle 40 includes a first rod 46 having a first end 48 operatively coupled to the flow control device, an opposing second end 50 forming a handle 52 to facilitate moving extension handle 40, and a midsection 54 slidably positioned within opening 44 defined through support member 42. In one embodiment, as shown in FIG. 6, first end 48 is bent or shaped to form a portion 56 that is received within opening 58 defined through actuator 36 to couple extension handle 40 to actuator 36. First end 48 further defines an aperture 59 sized to receive a pin, such as a cotter pin, or other suitable coupler to removably couple extension handle 40 to actuator 36 of flow control device 20.

In one embodiment, first end 48 of extension handle 40 is coupled to actuator 36 to move actuator 36 with respect to body 24. As shown in FIG. 2, in this embodiment, at least a portion of first rod 46 is positioned within a first plane parallel to a second plane within which actuator 36 is pivotally movable. First rod 46 is movable within the first plane to move actuator 36 within the second plane. Referring further to FIG. 2, the first plane and the second plane are generally horizontal such that extension handle 40 extends laterally outward from the underside of the railcar to facilitate operating actuator 36 without the operator having to crawl and/or reach underneath the railcar. Extension handle 40 is translationally movable with respect to support member 42 in a lateral direction within the first plane to pivotally move actuator 36 between the first position and the second position to close and open disk 28, respectively.

As shown in FIG. 6, in one embodiment, extension handle 40 includes a locking member 60 configured to lock or secure extension handle 40 to support member 42 with disk 28 in the open position or the closed position, as desired. Locking member 60 facilitates retaining disk 28 in the closed position during transport of the material between locations and in the open position during transfer of the material from the hopper into a suitable container for further transport and/or storage. More specifically, locking member 60 prevents or limits undesirable movement of valve 28 between the closed position and the open position due to movement and/or vibration of the railcar and/or the material discharge system components. Locking member 60 includes a second rod 62 that is coupled to midsection 54 of first rod 46. A first end 64 of second rod 62 interferes with support member 42 with disk 28 in the closed position and an opposing second end 66 of second rod 62 interferes with support member 42 with disk 28 in the open position. Second rod 62 has any suitable dimensions provided that second rod 62 is slidably positionable with first rod 46 within opening 44 of support member 42.

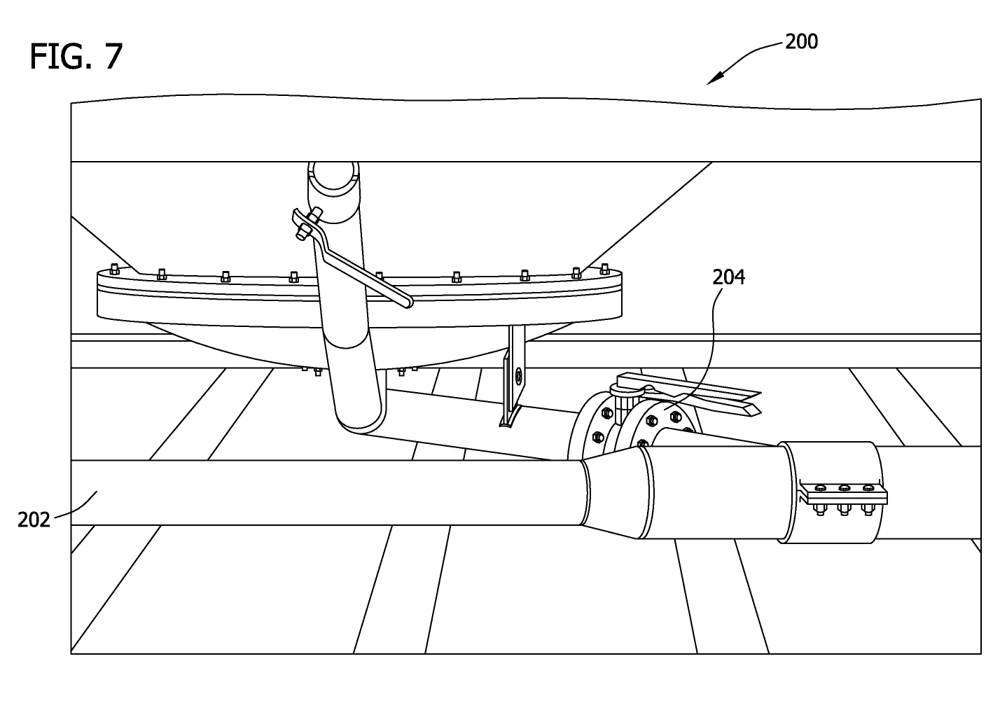

FIG. 7 is a side view of a railcar 200 with a material discharge system 202 that includes a valve system 204.

In one embodiment, a method for coupling an extension handle to a valve system of a railcar is provided. The railcar includes one or more hoppers each defining a volume for containing a material. The railcar also includes a material discharge system that includes one or more pipes defining a passage in material flow communication with the volume. A flow control device is operatively coupled to the pipe and includes a body defining a passage. A valve is movably positioned within the body passage. The valve is movable between an open position allowing material flow through the body passage and a closed position preventing or limiting fluid flow through the body passage. An actuator is operatively coupled to the valve and is pivotally movably with respect to the body to move the valve between the open position and the closed position. An extension handle is coupled to the actuator to pivotally move the actuator with respect to the body.

In a further embodiment, a method for coupling a valve system to a railcar is provided. The railcar includes one or more hoppers each defining a volume for containing a material. The railcar includes a material discharge system that includes one or more pipes defining a passage in material flow communication with the volume. A flow control device is operatively coupled to the pipe. The flow control device includes a body that defines a passage. A valve is movably positioned within the body passage and is movable between an open position allowing material flow through the body passage and a closed position limiting fluid flow through the body passage. An actuator is operatively coupled to the valve. The actuator is pivotally movably with respect to the body to move the valve between the open position and the closed position. An extension handle is coupled to the actuator to pivotally move the actuator with respect to the body. In a particular embodiment, a support member is coupled to the railcar. The support member defines an opening through which the extension handle is slidably positioned.

The above-described valve system and extension handle allows an operator to operate or control a flow control device of a material discharge system without having to crawl and/or reach under a railcar. More specifically, the extension handle facilitates moving a valve of the flow control device between a closed position to prevent material flow through the flow control device and an open position allowing material flow through the flow control device to facilitate transferring the material from within the hopper to a suitable container for further transport and/or storage. Because the extension handle extends laterally outward from underneath the railcar, the operator is able to control the fluid control device while standing on a side of the railcar and without having to crawl and/or reach under the railcar, thus, allowing the operator to safely and efficiently control material flow through the material discharge system of the railcar. Further, the support member of the valve system is coupled to the side sill of the railcar, for example, to support the extension handle in a generally horizontal plane to facilitate operating the actuator of the flow control device to move the valve between the open position and the closed position, as desired.

Exemplary embodiments of a method and system for controlling material flow through a material discharge system are described above in detail. The method and system are not limited to the specific embodiments described herein, but rather, steps of the method and/or components of the system may be utilized independently and separately from other steps and/or components described herein. Further, the described method steps and/or system components can also be defined in, or used in combination with, other methods and/or systems, and are not limited to practice with only the method and system as described herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An extension handle coupled to a flow control device of a railcar, the extension handle comprising a first rod having a first end operatively coupled to the flow control device, an opposing second end forming a handle, and a midsection slidably coupled to a support member coupled to the railcar.

2. An extension handle in accordance with claim 1 further comprising a locking member configured to lock the extension handle to the support member with the flow control device in one of an open position and a closed position.

3. An extension handle in accordance with claim 2 wherein the locking member comprises a second rod coupled to the midsection, a first end of the second rod interfering with the support member with the flow control device in the closed position and an opposing second end of the second rod interfering with the support member with the flow control device in the open position.

4. An extension handle in accordance with claim 1 wherein the first rod is parallel to an actuator of the flow control valve and movable within a plane to pivotally move the actuator.

5. An extension handle in accordance with claim 1 wherein the extension handle is removably coupled to the flow control device.

6. An extension handle in accordance with claim 5 wherein the first end of the first rod forms a portion positionable within an opening defined by an actuator of the flow control device to couple the extension handle to the flow control device.

7. An extension handle in accordance with claim 1 wherein the extension handle is translationally movable with respect to the support member between a first position to position the flow control device in an open position and a second position to position the flow control device in a closed position.

8. A valve system for a railcar including at least one hopper defining a volume for containing a material and a material discharge system including a pipe defining a first passage in material flow communication with the volume, the valve system comprising:
a flow control device operatively coupled to the pipe, the flow control device comprising:
a body defining a second passage, the first passage and the second passage in flow communication;
a valve movably positioned within the second passage, the valve movable between an open position allowing material flow through the second passage and a closed position limiting material flow through the second passage; and
an actuator operatively coupled to the valve, the actuator pivotally movable with respect to the body to move the valve between the open position and the closed position; and
an extension handle coupled to the actuator to pivotally move the actuator with respect to the body.

9. A valve system in accordance with claim 8 further comprising a support member coupled to the railcar, the support member defining an opening through which the extension handle is slidably positioned.

10. A valve system in accordance with claim 9 wherein the extension handle further comprises a locking member configured to lock the extension handle to the support member with the valve in one of the open position and the closed position.

11. A valve system in accordance with claim 10 wherein the locking member comprises a rod coupled to the extension handle, a first end of the rod interfering with the support member with the valve in the closed position and an opposing second end of the rod interfering with the support member with the valve in the closed position.

12. A valve system in accordance with claim 9 wherein the extension handle comprises a rod having a first end coupled to the actuator, an opposing second end forming a handle and a midsection slidably coupled to the support member.

13. A valve system in accordance with claim 12 wherein the rod is parallel to the actuator and movable within a plane to pivotally move the actuator.

14. A valve system in accordance with claim 8 wherein the flow control device comprises a butterfly valve, the butterfly valve comprising a body defining a second passage and a disk movably positioned within the second passage.

15. A valve system in accordance with claim 14 wherein the disk is positioned along a central axis of the body with the disk in an open position.

16. A valve system in accordance with claim 14 wherein the disk is positioned perpendicular to a central axis of the body with the disk in a closed position.

17. A valve system in accordance with claim 14 wherein the disk rotates 90° between an open position and a closed position.

18. A method for coupling an extension handle to a valve system of a railcar, the railcar including at least one hopper defining a volume for containing a material and a material discharge system including a pipe defining a first passage in material flow communication with the volume, and a flow control device operatively coupled to the pipe, the flow control device including a body defining a second passage, a valve movably positioned within the second passage, the valve movable between an open position allowing material flow through the second passage and a closed position limiting material flow through the second passage, and an actuator operatively coupled to the valve, the actuator pivotally movable with respect to the body to move the valve between the open position and the closed position, the method comprising coupling an extension handle to the actuator to pivotally move the actuator with respect to the body.

19. A method for coupling a valve system to a railcar, the railcar including at least one hopper defining a volume for containing a material and a material discharge system including a pipe defining a first passage in material flow communication with the volume, the method comprising:
operatively coupling a flow control device to the pipe, the flow control device comprising a body defining a second passage in flow communication with the first passage, a valve movably positioned within the second passage, the valve movable between an open position allowing material flow through the second passage and a closed position limiting material flow through the second passage, and an actuator operatively coupled to the valve, the actuator pivotally movable with respect to the body to move the valve between the open position and the closed position; and
coupling an extension handle to the actuator to pivotally move the actuator with respect to the body.

20. A method in accordance with claim 19 further comprising coupling a support member to the railcar, the support member defining an opening through which the extension handle is slidably positioned.
